(19) United States
(12) Patent Application Publication
(10) Pub. No.: US 2013/0278370 A1
(43) Pub. Date: Oct. 24, 2013

(54) SPRING-SUPPORTED INDUCTOR CORE

(71) Applicants: Adam M. Finney, Rockford, IL (US); Charles Shepard, DeKalb, IL (US); Kris H. Campbell, Poplar Grove, IL (US); Robert Scott Downing, Rockford, IL (US)

(72) Inventors: Adam M. Finney, Rockford, IL (US); Charles Shepard, DeKalb, IL (US); Kris H. Campbell, Poplar Grove, IL (US); Robert Scott Downing, Rockford, IL (US)

(73) Assignee: HAMILTON SUNDSTRAND CORPORATION, Windsor Locks, CT (US)

(21) Appl. No.: 13/449,706

(22) Filed: Apr. 18, 2012

(51) Int. Cl. H01F 27/08; H01F 27/29; H01F 17/04

(52) U.S. Cl. 336/60; 336/221; 336/192

(57) ABSTRACT

An inductor comprises a ferromagnetic core, a plurality of conductor turns encircling the ferromagnetic core, a bobbin, and a wave spring. The bobbin encloses the ferromagnetic core and supports the plurality of conductor turns and the wave spring is situated between the bobbin and the ferromagnetic core.

### BACKGROUND

The present invention relates generally to ferromagnetic core inductors, and more particularly to support structures for ferromagnetic inductor cores.

Inductors are passive electronic components which store electrical energy in magnetic fields. Ferromagnetic core inductors have two principal components: a rigid core of ferromagnetic or ferrimagnetic material, and a conductor, usually wound about the core in one or more turns. Some inductors include multiple phases of coils. Inductors are characterized by an inductance L which resists changes in current through the conductor. According to Faraday's law, the magnetic flux induced by changing current through the conductor generates an opposing electromotive force opposing the change in voltage. For a ferromagnetic inductor with a rectangular cross-section toroidal core,

$$L = 0.01170 {N}^{2} h {log}_{10} \frac{{d}_{2}}{{d}_{1}}$$

Where L=inductance (μH), μ₀=permeability of free space=4π*10⁻⁷ H/m, N=number conductor turns, h=core height (in), d₁=core inside diameter (in), and d₂=core outside diameter (in).

Real-world inductors are not perfectly energy efficient. During operation, ferromagnetic core inductors radiate heat both from core losses, and from series resistance. Liquid and immersion cooling configurations house the inductor within a sealed housing containing a coolant fluid. At least one connection with the conductor extends through the housing, allowing the inductor to be contacted externally. Liquid and immersion cooling configurations require fluid passages between inductor cores and inductor conductors.

Many aircraft electronics use inductors. The cores of liquid cooled inductors to be used in aircraft electronics could shift relative to conductor coils, during flight. This shifting would make maintaining proper fluid passage between inductor cores and inductor conductors difficult.

### SUMMARY

The present invention is directed toward an inductor comprising a ferromagnetic core, a plurality of conductor turns encircling the ferromagnetic core, a bobbin, and a wave spring. The bobbin encloses the ferromagnetic core and supports the plurality of conductor turns, and the wave spring is situated between the bobbin and the ferromagnetic core.

### BRIEF DESCRIPTION OF THE DRAWINGS

FIG. 1a is an exploded perspective view of a core and wave springs of an inductor according to the present invention.

FIG. 1b is a cross-sectional view of the core and wave springs of FIG. 1a.

FIG. 2a is a perspective view of the inductor of FIG. 1a, with a bobbin and three phases of windings.

FIG. 2b is a cross-sectional view of the inductor of FIG. 2a.

### DETAILED DESCRIPTION

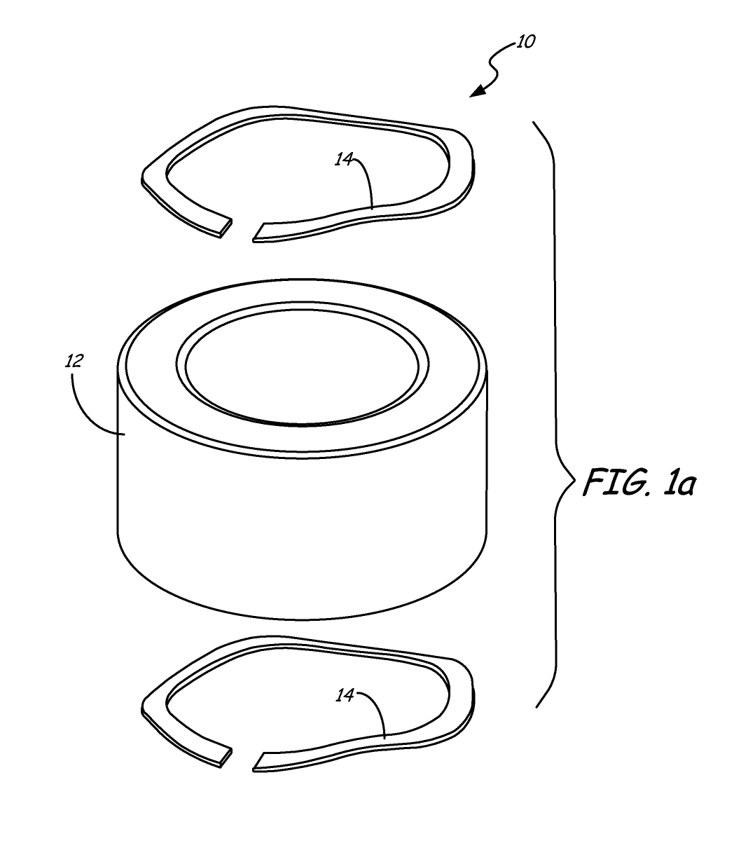

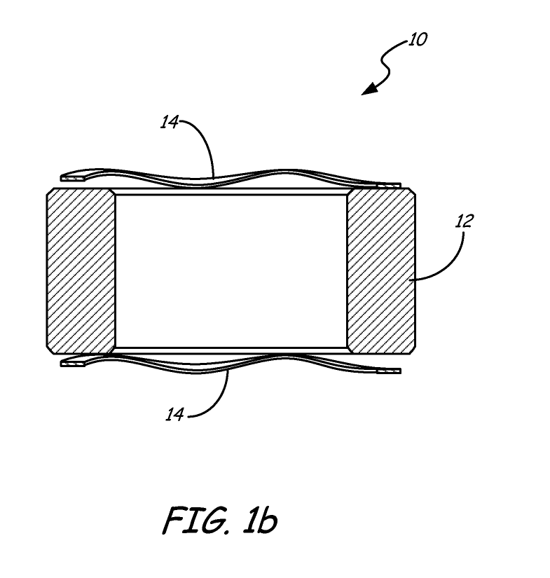

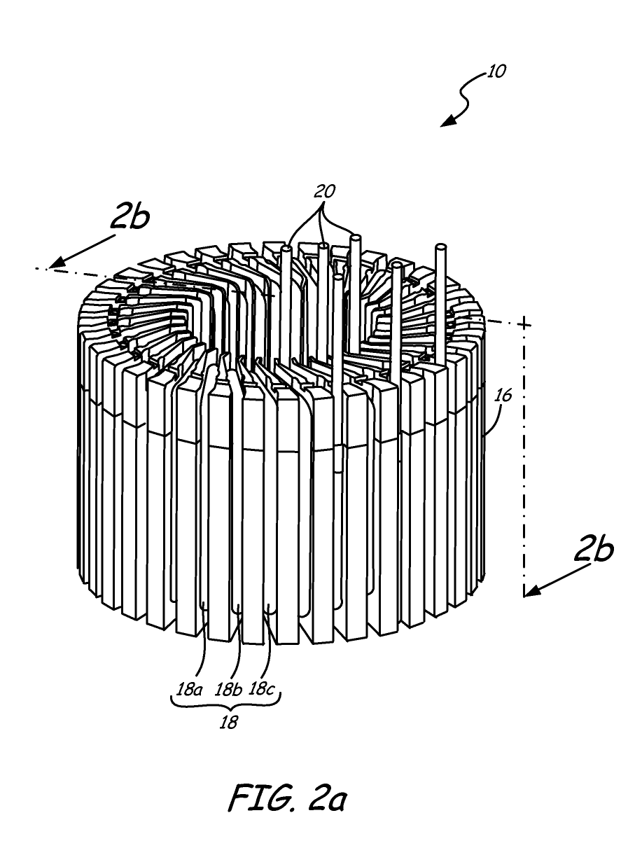

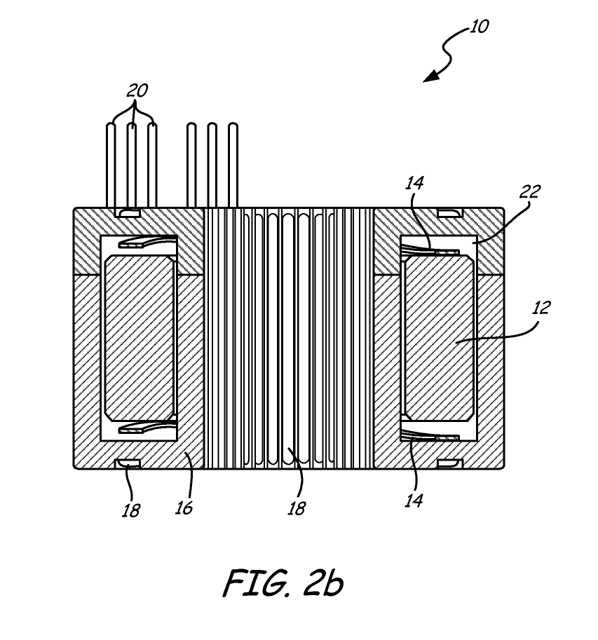

FIGS. 1a and 1b depict core 12 and wave springs 14 of inductor 10. FIG. 1a provides an exploded perspective view of inductor 10, while FIG. 1b provides a cross-sectional view of inductor 10. FIGS. 1a and 1b do not depict inductor 10 in its fully assembled state. In particular, FIGS. 1a and 1b do not show conductors 18, which encircle core 12 and are described below with respect to FIGS. 2a and 2b.

Inductor 10 is a ferromagnetic core inductor, and core 12 is a toroidal ferromagnetic core with a rectangular cross-section. Core 12 is formed of a material with high magnetic permeability, such as iron or ferrite. During operation of inductor 10, core 12 serves to confine magnetic fields induced by changing current through conductors 18 (see FIG. 2, below). Alternative embodiments of inductor 10 may include variants of core 12 with non-rectangular cross-sections, or which are not toroidal in shape. Wave springs 14 for such embodiments might similarly not be ring-shaped.

Wave springs 14 are conventional ring-shaped wave springs. Wave springs 14 are stacked atop and beneath core 12. When inductor 10 is fully assembled, wave springs 14 abut core 12 as seen in FIG. 1b. Wave springs 14 support bobbin 16, which in turn carries conductors 18 (see FIG. 2b, below).

FIGS. 2a and 2b depict bobbin 16, conductors 18 (including conductor 18a, conductor 18b, and conductor 18b), pins 20, and coolant passage 22. FIG. 2a provides a perspective view of inductor 10, while FIG. 2b provides a cross-sectional view of inductor 10 through sectional plane 2b-2b (shown in FIG. 2a). FIGS. 2a and 2b include all of the components shown in FIGS. 1a and 2b, as well as bobbin 16, conductors 18, and pins 20. Core 12 and wave spring 14 are not visible in FIG. 2a, but are enclosed inside bobbin 16, as shown in FIG. 2b. FIGS. 2a and 2b represent inductor 10 in its fully-assembled state.

As described above with respect to FIG. 1, inductor 10 is a conventional ferromagnetic core inductor. Conductors 18 are conductive coils which wrap about core 12. In the depicted embodiment, conductors 18 include three phases of conductors 18a, 18b, and 18c, each with two separate pins 20. Each phase of conductor 18 corresponds to a voltage phase of input and output to inductor 10. Conductors 18 may be formed, for instance, of copper wires or bundles of wires such as Litz wires. Pins 20 are electrical contact points to conductors 18, and allow inductor 10 to be connected to external electronics.

Bobbin 16 is a rigid or semi-rigid nonconductive toroidal support structure which positions and restrains conductors 18 about core 12, and aligns pins 20 with connections to external electronics. As shown in FIG. 2a, bobbin 16 includes a plurality of grooves corresponding to and locating conductors 18. Bobbin 16 does not provide a fluid seal about core 12; rather, fluid may pass through or around bobbin 16 to cool core 12 and conductors 18. Bobbin 16 may be formed from two or more pieces that assemble about core 12, such as a top and bottom half or a right and left half. Bobbin 16 maintains desired spacing between conductors 18, and supports conductors 18 with respect to core 12. Tolerances between core 12 and bobbin 16 are relatively loose, and are occupied snugly by wave springs 14.

Wave springs 14 fit atop and beneath core 12, between core 12 and bobbin 16. In some embodiments, bobbin 16 and/or core 12 may include slots which serve to locate wave springs 14. Wave springs 14 can be compressed to fit tolerances between core 12 and bobbin 16, and serve to define coolant passages 22. Coolant passages 22 include passage above and below core 12, defined by wave spring 14. In particular, wave springs 14 substantially equalize flow area through coolant passages 22 above and below core 12 by supporting core 12 substantially equidistant from top and bottom interior surfaces of bobbin 16. As mentioned above, cores of inductors in aircraft applications may shift during flight. Wave spring 14 supports core 12 relative to bobbin 16 (and thereby conductor 18), and maintains coolant passages 22 during flight.

The entirety of inductor 10, as depicted in FIGS. 2a and 2b, may be enclosed in a sealed housing configured to retain coolant fluid. Alternatively, inductor 10 may be situated in a larger electronics enclosure shared with other electronic components. In either case, inductor 10 may, for instance, be cooled by immersion or liquid cooling. In these embodiments, some portion of coolant passages 22 may be filled with liquid coolant which evaporates during operation as core 12 and conductors 18 radiate heat. Coolant vapor then circulates throughout coolant passages 22, convectively cooling core 12 and conductors 18.

Although inductor 10 is depicted with only two wave springs 14, some embodiments of inductor 10 may feature additional wave springs or other support components along the radially outer surface of core 12, which similarly support core 12 relative to bobbin 16. Wave springs 14 ensure that coolant passages 22 remain open even as core 12 shifts during flight or other movement of inductor 10. By supporting core 12 and maintaining coolant passages 22, wave springs 14 allow core 12 and conductors 18 to be uniformly cooled despite large tolerances between core 12 and bobbin 16, and despite movement of core 12.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An inductor comprising:
a ferromagnetic core;
a plurality of conductor turns encircling the ferromagnetic core;
a bobbin enclosing the ferromagnetic core and supporting the plurality of conductor turns; and
a first wave spring situated between the bobbin and the ferromagnetic core.

2. The inductor of claim 1, wherein the ferromagnetic core is toroidal in shape.

3. The inductor of claim 2, wherein the ferromagnetic core has a rectangular cross-section.

4. The inductor of claim 2, wherein the wave spring is substantially circular or ring-shaped.

5. The inductor of claim 1, wherein the plurality of conductor turns are comprised of Litz wire.

6. The inductor of claim 1, wherein the plurality of conductor turns comprises a distinct set of turns for each of several voltage phases.

7. The inductor of claim 1, wherein the wave spring abuts the bobbin and the ferromagnetic core, and fits snugly between the bobbin and the ferromagnetic core.

8. The inductor of claim 1, wherein the bobbin is formed of a non-conductive material.

9. The inductor of claim 1, further comprising a conductive pin extending from the conductor turns to provide a contact point for external electronics.

10. The inductor of claim 9, wherein the bobbin aligns the conductive pin with external electronics connections.

11. The inductor of claim 1, further comprising a second wave spring situated between the bobbin and the ferromagnetic core, and on an opposite side of the ferromagnetic core from the first wave spring.

12. The inductor of claim 11, wherein the first and second wave springs are configured to space the ferromagnetic core substantially equidistant between opposite interior sides of the bobbin.

13. A support structure configured to support an inductor core relative to a plurality of conductor turns, the support structure comprising:
a toroidal bobbin which supports and retains the plurality of conductor turns, and surrounds the inductor core;
a first wave spring situated between the inductor core and a top interior side of the bobbin to define a first coolant passage of a first height between the bobbin and the inductor core; and
a second wave spring situated between the inductor core and a bottom interior side of the bobbin to define a second coolant passage of a second height between the bobbin and the inductor core.

14. The support structure of claim 13, wherein the toroidal bobbin includes a plurality of slots or grooves configured to receive conductor turns.

15. The support structure of claim 13, wherein the toroidal bobbin is fluid-permeable.

16. The support structure of claim 13, wherein the first and second wave springs are substantially ring-shaped elements which abut the inductor core and the toroidal bobbin.

17. The support structure of claim 13, wherein the first and second wave springs support the inductor core in a position substantially equidistant from top and bottom internal surfaces of the toroidal bobbin.

18. The support structure of claim 13, wherein the toroidal bobbin further supports and retains a plurality of conductive pins electrically connected to the conductor turns, and configured to serve as electrical contacts to external electronics.

19. An inductor comprising:
a ferromagnetic core;
a plurality of conductor turns encircling the ferromagnetic core;
a bobbin enclosing the ferromagnetic core and supporting the plurality of conductor turns; and
a substantially circular or ring-shaped first wave spring situated between the bobbin and the ferromagnetic core.

20. The inductor of claim 19, further comprising a second wave spring situated between the bobbin and the ferromagnetic core, and on an opposite side of the ferromagnetic core from the first wave spring.
